(19) United States
(12) Patent Application Publication
(10) Pub. No.: US 2023/0324984 A1
(43) Pub. Date: Oct. 12, 2023

(54) ADAPTIVE SENSORS TO ASSESS USER STATUS FOR WEARABLE DEVICES

(71) Applicant: Meta Platforms Technologies, LLC, Menlo Park, CA (US)

(72) Inventors: Doruk Senkal, Redmond, WA (US); Sebastian Sztuk, Virum (DK); Nan Wang, Sunnyvale, CA (US); Johana Gabriela Coyoc Escudero, Milpitas, CA (US)

(21) Appl. No.: 18/186,416

(22) Filed: Mar. 20, 2023

Related U.S. Application Data
(60) Provisional application No. 63/323,930, filed on Mar. 25, 2022.

(51) Int. Cl. G02B 27/01; G02B 27/00; G06F 3/01; G06F 3/044

(52) U.S. Cl. CPC G06F 3/011; G02B 27/0093; G02B 27/017; G06F 3/044; G02B 2027/0138; G02B 2027/0178

(57) ABSTRACT

A device is provided, including a frame that supports two eyepieces, a capacitive sensor mounted on the frame, an inertial measurement unit mounted on the frame, and a circuit component inside the frame, wherein the circuit component electrically couples the capacitive sensor and the inertial measurement unit with a processor and a memory inside the frame. A method for using the above device is also provided.

### CROSS-REFERENCE TO RELATED APPLICATIONS

The present disclosure is related, and claims priority under 35 U.S.C. §119(e), to US Prov. Appln. No. 63/323,930, filed on Mar. 25, 2022, entitled ADAPTIVE SENSORS TO ASSESS USER STATUS FOR WEARABLE DEVICES, to Doruk SENKAL, et al., the contents of which are hereby incorporated by reference in their entirety, for all purposes.

### BACKGROUND

### Field

The present disclosure is directed to sensors for wearable devices. More specifically, embodiments as disclosed herein are directed to adaptive sensors to assess user status and device status in headsets and smart glasses.

### Related Art

In the field of wearable devices, sensors are critical to correctly assess a user command or status, and also to determine whether the device should be placed in active mode or in sleep mode, to save power. In the case of headsets and smart glasses, there are many different configurations that may be indicative of the device not being used, and thus a complex set of conditions and sensors is desirable to accurately assess the device status. Moreover, head movements of a user are typically indicative of precise user intentions or cognitive reactions. However, accurate sensors to assess user status and intentions and device status is lacking for headsets and smart glasses.

### SUMMARY

In a first embodiment, a device includes a frame that supports two eyepieces, a capacitive sensor mounted on the frame, an inertial measurement unit mounted on the frame, and a circuit component inside the frame, wherein the circuit component electrically couples the capacitive sensor and the inertial measurement unit with a processor and a memory inside the frame.

In a second embodiment, a computer-implemented method includes receiving, from a contact or proximity sensor mounted on a frame of a headset, a contact signal above a first threshold value, receiving, from an inertial measurement unit mounted on the frame of the headset, an inertial signal indicative of an orientation of the headset relative to a vertical direction, and identifying a status of the headset as one of an active status or a sleep status, based on the contact signal and the inertial signal.

In a third embodiment, a non-transitory, computer-readable medium including instructions which, when executed by a processor, cause a computer to perform operations. The operations include receiving, from a contact or proximity sensor mounted on a frame of a headset, a contact signal above a first threshold value, receiving, from an inertial measurement unit mounted on the frame of the headset, an inertial signal indicative of an orientation of the headset relative to a vertical direction, identifying a status of the headset as one of an active status or a sleep status, based on the contact signal and the inertial signal, switching the status of the headset between the active status and the sleep status, based on the contact signal and the inertial signal, and wirelessly transmitting, via a communications module, a signal to a remote device indicative of the active status or the sleep status of the headset.

In another embodiment, a system includes a memory storing instructions and one or more processors configured to execute the instructions and cause the system to perform operations. The operations include to receive, from a contact or proximity sensor mounted on a frame of a headset, a contact signal above a first threshold value, to receive, from an inertial measurement unit mounted on the frame of the headset, an inertial signal indicative of an orientation of the headset relative to a vertical direction, and to identify a status of the headset as one of an active status or a sleep status, based on the contact signal and the inertial signal.

In other embodiment, a system includes a first means for storing instructions, and a second means for executing the instructions to cause the system to perform a method. The method includes receiving, from a contact or proximity sensor mounted on a frame of a headset, a contact signal above a first threshold value, receiving, from an inertial measurement unit mounted on the frame of the headset, an inertial signal indicative of an orientation of the headset relative to a vertical direction, and identifying a status of the headset as one of an active status or a sleep status, based on the contact signal and the inertial signal.

In one embodiment, a headset configured for virtual reality, mixed reality, or augmented reality applications includes cameras to capture the eye and face region of the user, which combined with contact, proximity signals from a Hall sensor, and inertial measurement signals, are able to identify a status of the headset.

These and other embodiments will be clear to one of ordinary skill in light of the following.

### BRIEF DESCRIPTION OF THE FIGURES

FIG. 1 illustrates an architecture including one or more wearable devices coupled to one another, to a mobile device, a remote server and to a database, according to some embodiments.

FIG. 2 illustrates an inactive smart glass set with temples folded, according to some embodiments.

FIG. 3 illustrates an inactive smart glass set face-down on a surface, according to some embodiments.

FIGS. 4A-4B illustrate a user wearing an inactive smart glass, on the forehead or in the back of the head, according to some embodiments.

FIG. 5 illustrates a user nodding/shaking its head as a cognitive response to an augmented reality input from a smart glass, according to some embodiments.

FIG. 6 illustrates a chart indicating some of the power states of a smart glass and the transition thereof based on different sensor signals, according to some embodiments.

FIG. 7 is a flow chart illustrating steps in a method for assessing user status for wearable devices, according to some embodiments.

FIG. 8 is a block diagram illustrating an exemplary computer system with which a smart glass and methods for use can be implemented, according to some embodiments.

In the figures, elements having the same or similar reference numerals are associated with the same or similar attributes or features, unless explicitly stated differently, otherwise.

### DETAILED DESCRIPTION

In the following detailed description, numerous specific details are set forth to provide a full understanding of the present disclosure. It will be apparent, however, to one ordinarily skilled in the art, that embodiments of the present disclosure may be practiced without some of these specific details. In other instances, well-known structures and techniques have not been shown in detail so as not to obscure the disclosure.

Headsets and smart glasses used in virtual reality (VR), augmented reality (AR) or mixed reality (MR) applications may be carried or left over a surface by users in multiple configurations, while not being activated. For example, a user may carry a headset over the hairline, or facing backwards. In some instances, the user may lay the smart glasses on a table (folded or not, facing down on a hard surface, and the like). It is desirable that the smart glass have hardware (e.g., sensors) and software to correctly identify these different configurations to set the device on a sleep mode to reduce power consumption. Likewise, it is expected that the device be rapidly activated once the user is ready to interact with the smart glass. Accordingly, in embodiments disclosed herein, devices such as smart glasses include highly sensitive capacitive touch sensors combined with accelerometers and other inertial measurement units (IMUs), to correctly identify user status and device status.

When the device is in active mode, highly sensitive IMU sensors may be used to identify a head shake, or nod, from the user, indicating a cognitive reaction to VR/AR/MR content displayed on the smart glass or headset. This could also work with audio-only glasses to control music or accept / reject a call, and with camera-only glasses to trigger capture by head gestures.

In some embodiments, single capacitive cells may be configured as one-point contact sensors in different parts of a smart glass to provide a verification signal for smart glass usage and proper wearing by the user. In addition, in some embodiments, a camera in the smart glass may be used to identify non-active use of the device (e.g., when the camera points to a ceiling, the back of the user’s head, or is blocked by a surface at close range).

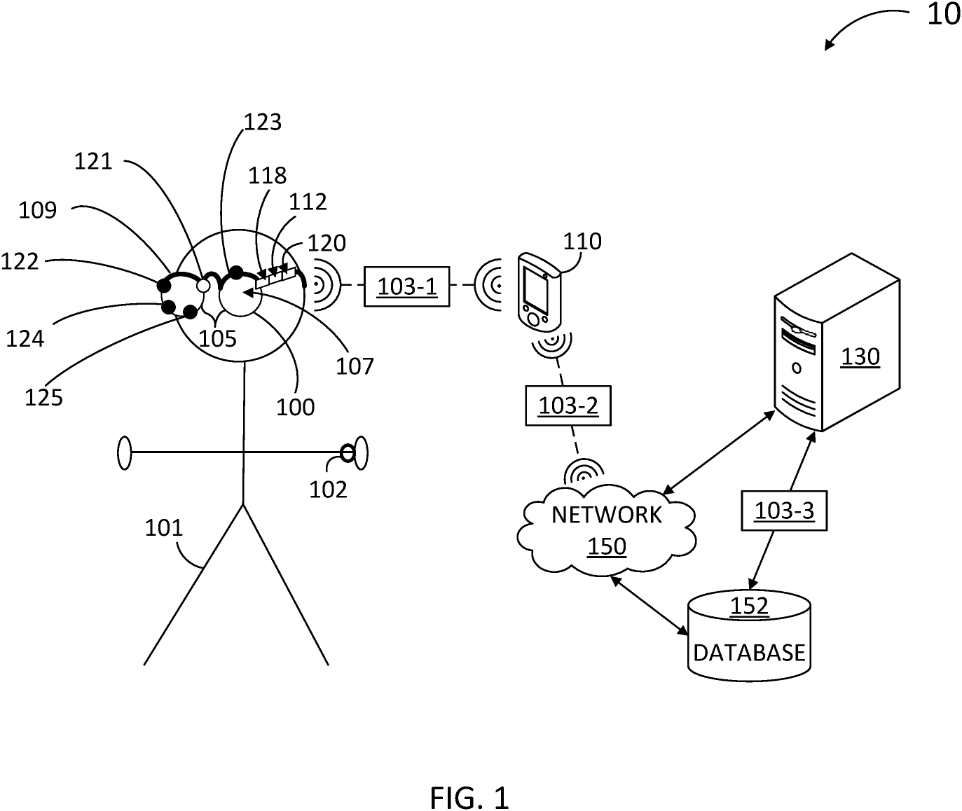

FIG. 1 illustrates an architecture 10 including a smart glass 100, and a wearable device 102, coupled to one another, to a mobile device 110 (e.g., a smart phone), a remote server 130 and to a database 152, according to some embodiments. All the devices in network 10 may communicate with one another via wireless communications and exchange a first dataset 103-1. Dataset 103-1 may include a recorded video, audio, or some other file or streaming media. The user of wearable device 102 and headset 100 is also the owner or is associated with mobile device 110. In some embodiments, smart glass 100 may directly communicate with remote server 130, database 152, or any other client device (e.g., a smart phone of a different user, and the like) via network 150. Mobile device 110 may be communicatively coupled with remote server 130 and database 152 via network 150, and transmit/share information, files, and the like with one another, e.g., dataset 103-2 and dataset 103-3, hereinafter, collectively referred to as “datasets 103.”

Smart glass 100 may include an augmented reality (AR) display 107 in at least one of two eyepieces 105. In some embodiments, smart glass or headset 100 may include multiple sensors such as IMUs, gyroscopes and accelerometers 121, barometers, magnetometers, ambient light sensors, proximity sensors, microphones 124, cameras 123, and capacitive sensors 125, configured as contact interfaces for different parts of the user’s body/head.

Other contact sensors 125 may include a pressure sensor, a thermometer, and the like. In some embodiments, the thermometer may detect when a smart glass or headset is on the face of a person by detecting heat from the face. Smart glass 100 may also include a hinge sensor 122, to determine the position configuration of the hinge that allows the temple in the smart glass frame to open/close for the user to wear/store the smart glasses. Hinge sensor 122 may include a hall sensor, a magnetic sensor, a capacitive sensor, or an optical sensor, such as an infrared (IR) sensor including a source and a detector in a sensing package.

In some embodiments, cameras 123 may include a forward-looking camera mounted on a frame 109 and configured to collect images of a forward view. In some embodiments, the image of a forward view may be an image of a blocking object (e.g., a hard surface), or some other irrelevant image such as a ceiling or the floor, or an image that remains static with no indication of motion for a pre-selected period of time. The above scenarios may be indicative that smart glass 100 is not being actively used and it may be desirable to switch it from an active mode to a sleep mode. In some embodiments, cameras 123 may include a backward-looking camera (e.g., an eye or face tracking camera) mounted on frame 109 and configured to collect an image of a portion of the face of user 101, including one or both eyes. Accordingly, when the image from the face indicates that user 101 is not present, or it has both eyes shut for a pre-selected period of time, a processor 112 may determine that smart glass 100 may be desirably switched from an active mode to a sleep mode. In some embodiments, a signal provided by an eye tracking device may be used to infer whether the user is wearing smart glass 100 or not. For example, an eye tracking device may receive in a holographic optical element (HOE) combiner a reflection of a portion of the eyes of user 101 when illuminated by an infrared -IR- radiation.

In addition, smart glass 100 and/or mobile device 110 may include a memory circuit 120 storing instructions, and processor 112 is configured to execute the instructions to cause smart glass 100 and/or mobile device 110 to perform, at least partially, some of the steps in methods consistent with the present disclosure. In some embodiments, artificial intelligence (AI) algorithms may be used to train sensors and devices 121, 122, 123, 124, and 125 on the behavior of user 101, thus improving detection accuracy. In some embodiments, smart glass 100, mobile device 110, server 130, and/or database 152 may further include a communications module 118 enabling the device to wirelessly communicate with server 130 via network 150. Smart glass 100 may thus download a multimedia online content (e.g., dataset 103-1) from remote server 130, to perform at least partially some of the operations in methods as disclosed herein. In some embodiments, memory 120 may include instructions to cause processor 112 to receive and combine signals from the IMU sensors 121, hinge sensors 122, microphones 124, capacitive sensors 125, and other contact sensors, avoid false positives, and better assess user intentions and commands when a touch signal is received.

In some embodiments, capacitive sensors 125 are configured to provide a contact signal indicative of a contact of frame 109 with a face of user 101, and to detect proximity via fringe field detection, and IMU sensors 121 are configured to provide an orientation signal indicative of an orientation of two eyepieces 105 relative to a vertical position, and wherein processor 112 is configured to identify an active use of smart glass 100 based on the contact signal and the orientation signal. AR display 107 may be configured to provide an image to user 101 when processor 112 determines that user 101 intends to activate smart glass 100 based on a signal from capacitive sensor 125 and a signal from IMU sensor 121. In some embodiments, IMU sensor 121 is configured to provide a first signal for a sideways swing of the head of user 101 and a second signal for an up-down swing of the head of user 101, and processor 112 is configured to identify a negative response to an augmented reality content when receiving the first signal and a positive response to the augmented reality content when receiving the second signal.

In some embodiments, processor 112 is configured to switch smart glass 100 from an active mode into a sleep mode or from a sleep mode into an active mode, based on a first signal from capacitive sensor 125 and a second signal from IMU sensor 121. In some embodiments, processor 112 may keep the system active but stop/play music or redirect audio from a call to another BT device or the host device (e.g., similar to an earbud). In some embodiments, processor 112 is configured to switch smart glass 100 from an active mode into a sleep mode or from a sleep mode into an active mode based on a signal from hinge sensor 122, the signal indicative of one of a folding or an unfolding of a temple over frame 109. In some embodiments, processor 112 is configured to switch smart glass 100 from an active mode into a sleep mode or from a sleep mode into an active mode, based on an image provided by forward-facing camera 123 mounted on frame 109. In some embodiments, communications module 118 is electrically coupled with processor 112, and is configured to wirelessly transmit a signal to a remote device inductive of an active status or a sleep status of the device (e.g., smart glass 100, or wristband wearable 102).

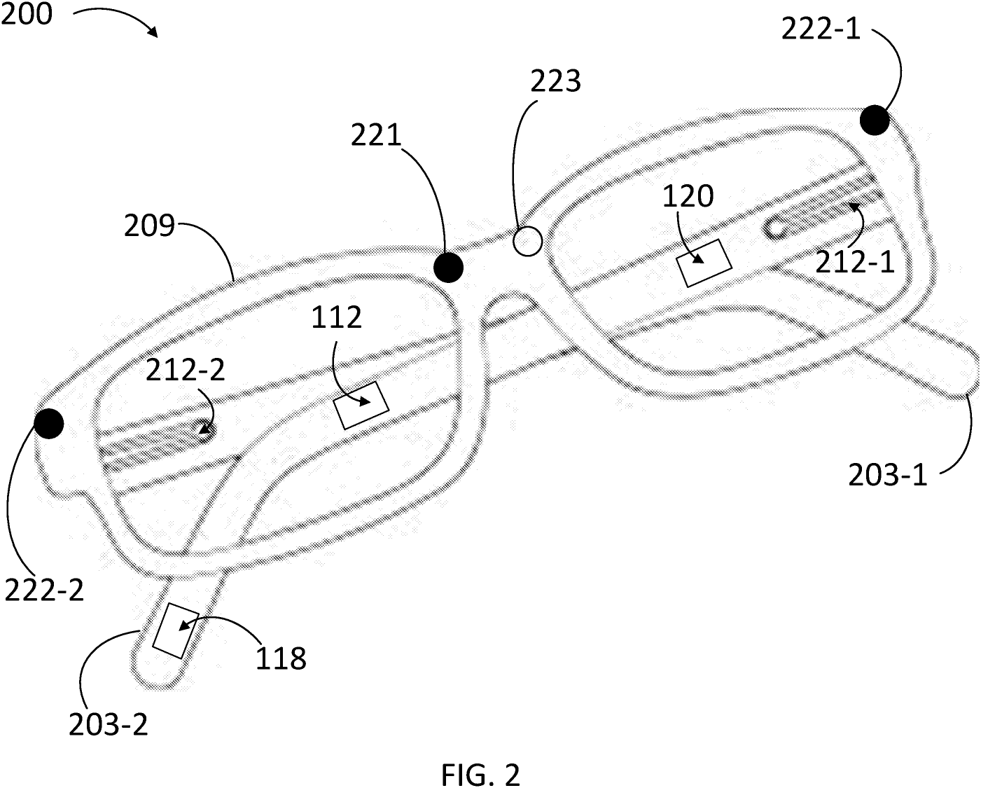

FIG. 2 illustrates an inactive smart glass 200 with temples 203-1 and 203-2 (hereinafter, collectively referred to as “temples 203”) folded, according to some embodiments. Smart glass 200 includes an IMU sensor 221, a camera 223, a memory 120, and a processor 112, consistent with the present disclosure. In such configuration, hinges 212-1 and 212-2 (hereinafter, collectively referred to as “hinges 212”) coupling frame 209 with temples 203 are closed (e.g., smart glass 200 is sitting on a table or counter, facing upward). To ensure users or bystanders feel comfortable with their privacy protection, processor 112 may put smart glass 200 into a sleep mode when hinge sensors 222-1 and 222-2 (hereinafter, collectively referred to as “hinge sensors 222”) detect the closed status of one or two of the hinges 212.

In some embodiments, hinge sensors 222 may include a hall sensor to detect a closed hinge 212. In addition, in some embodiments, processor 112 may receive IMU data to further assess the inactivity of smart glass 200. A communications module 118 transmits and receives data from an external device or network, as described above (cf. mobile device 110, network 150, server 130).

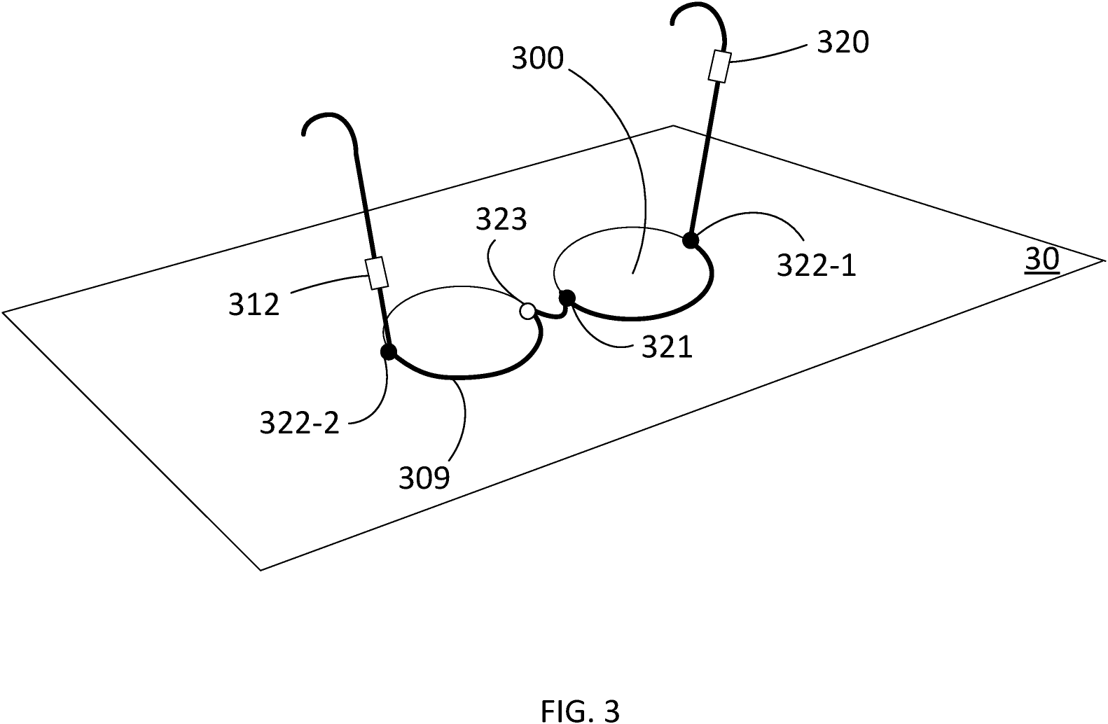

FIG. 3 illustrates an inactive smart glass 300 face-down on a surface (or table) 30, according to some embodiments. A camera 323, an IMU sensor 321, and one or two hinge sensors 322-1 and 322-2 (hereinafter, collectively referred to as “hinge sensors 322”) may be mounted on frame 309. Smart glass 300 also includes a processor 312 and a memory 320, as disclosed herein.

Accordingly, camera 323 and IMU sensor 321 may provide dates with which processor 312 identifies when the user is wearing smart glasses 300 upside down or smart glasses 300 are sitting on table 30, upside down. In such configurations, it may be desirable that smart glass 300 be set into a sleep mode, to avoid unnecessary power consumption. In addition, IMU sensor 321 may track tilt angle and record the state in memory 320. Data from IMU sensor 321 stored during a capture of camera 323, may be used for image post processing.

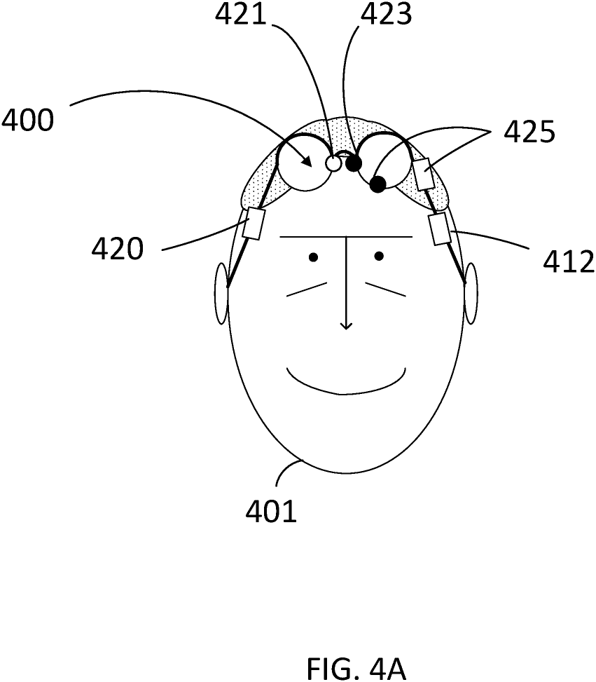

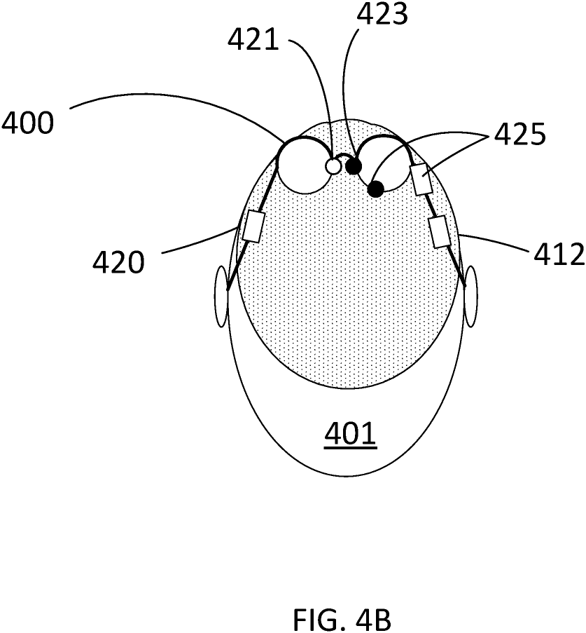

FIGS. 4A-4B illustrate a user 401 wearing an inactive smart glass 400, on the forehead (FIG. 4A) or in the back of the head (FIG. 4B), according to some embodiments. When user 401 is wearing smart glasses 400 on the forehead, or in the back of the head (facing backward), smart glass 400 is likely not in use, or inactive. In this configuration, user 401 usually does not expect smart glass 400 to be active and/or the device could be customized to user preferences with a gesture/movement trigger. Accordingly, processor 412 identifies this state based on a signal provided by IMU sensor 421 (e.g., indicating a tilt angle when user 401 has glasses 400 on the forehead, glasses 400 will be tilted slightly upwards), a capacitive sensor 425, and/or a camera 423, to put smart glass 400 to sleep. Capacitive sensor 425 may include an array (on left and right temple arms and frame). A memory 420 stores data and instructions for processor 412 to execute operations as disclosed herein.

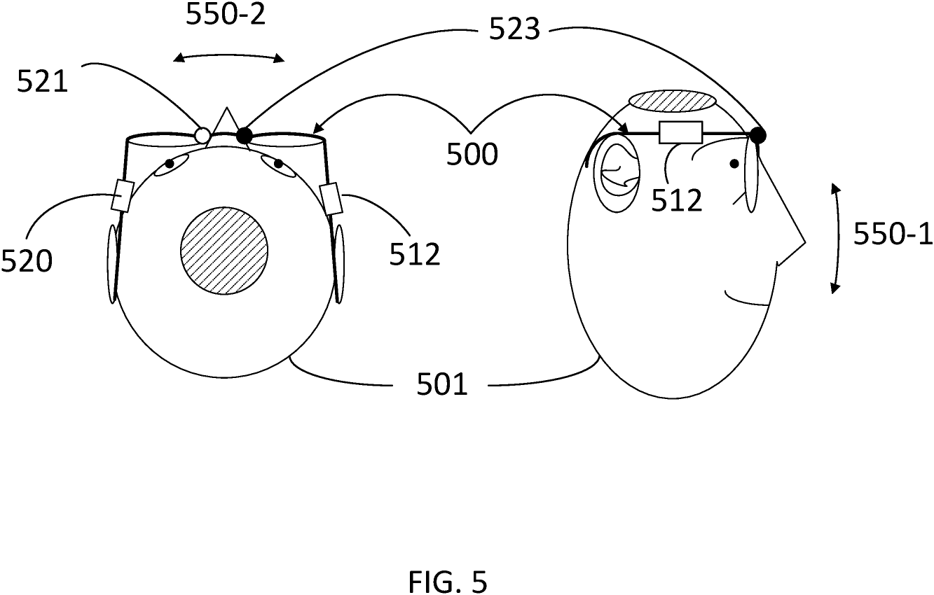

FIG. 5 illustrates a user 501 nodding 550-1 / shaking 550-2 (hereinafter, collectively referred to as “head gestures 550”) its head as a cognitive response to an augmented reality input from a smart glass 500, according to some embodiments. Smart glass 500 includes a camera 523, a memory, a processor, and an IMU sensor 521, consistent with the present disclosure. In some embodiments, when user 501 interacts with an AR application in smart glass 500, user 501 prefers to use micro head movement to confirm yes or no to smart glass 500. Such scenario may occur in a noisy restaurant or indoor situation where audio commands are buried by noise or in very quiet places when voice commands are not socially acceptable (e.g., class, church, an auditorium or concert hall, and the like).

Accordingly, the AR application in smart glass 500 may include user interface via head gestures 550. For example, a nod 550-2 twice may be interpreted by processor 512 as a “YES,” and a left-to-right (or vice-versa) shake of the head 550-2 may be interpreted by processor 512 as a “NO.” A memory 520 stores instructions to be executed by sensor 512. In some embodiments, the user interface may be assisted with gaze tracking and scene understanding and contextualization, to identify which object the user intends to interact with.

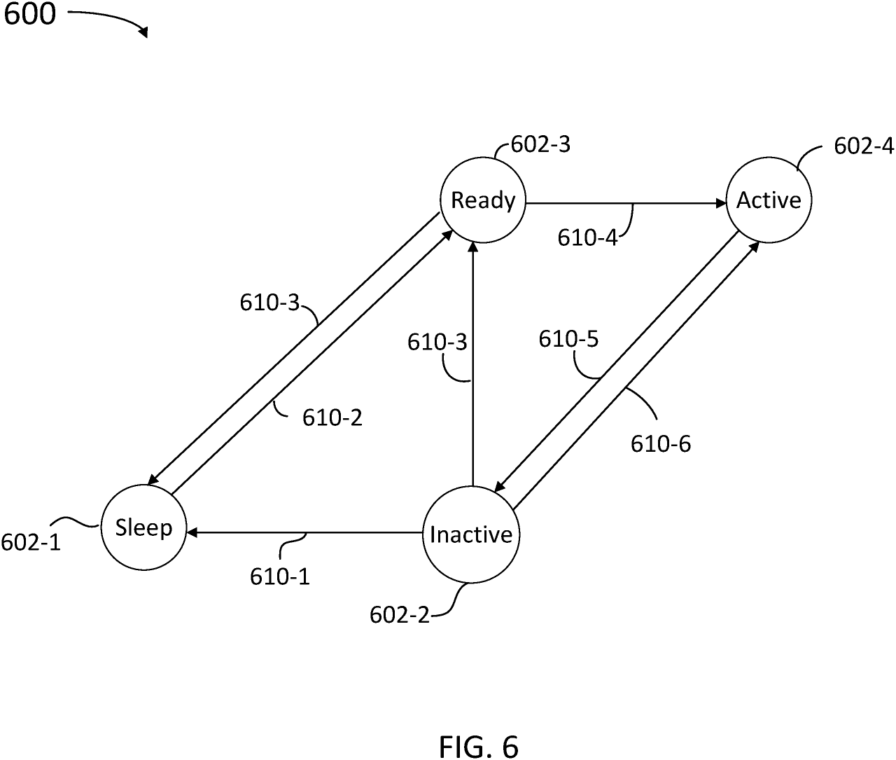

FIG. 6 illustrates a chart 600 indicating some of the power states 602-1 (‘sleep’), 602-2 (‘inactive’), 602-3 (‘ready’), and 602-4 (‘active,’ hereinafter, collectively referred to as “power states 602”), of a smart glass and the transition thereof based on different sensor signals (610-1, 610-2, 610-3, 610-4, 610-5 and 610-6, collectively referred to as “sensor signals 610”), according to some embodiments. In some embodiments, sleep state 602-1 may be the lowest power consumption state. Inactive state 602-2 may consume more power than sleep state 602-1, as some radio receivers and sensors may be kept ‘on’ to set the device into ready state 602-3, somewhat more power, or into an active state 602-4 (full power ‘on’). In the active state 602-4, all sensors and radio transceivers are ‘on,’ and operating. For example, in active state 602-4 the camera may start collecting a video and an immersive reality application (VR/AR/MR) may be active as well.

Signal 610-1 leading to sleep state 602-1 from inactive state 602-2 may include a time lapse beyond a selected threshold during which the smart glass has been inactive. A signal 610-3 inducing sleep state 602-1 may include a lack of skin contact with the user’s face, or a camera picture of flat, featureless field indicative that the smart glass is facing a wall, a flat surface, the ceiling or the sky (cf. FIG. 3). Accordingly, signal 610-3 may be indicative that the smart glass has been dropped, abandoned, forsaken or set away intentionally, by the user. When an opposite event occurs (the user finds the device and flips it on her/his face, a signal 610-2 may set the device to ready state 602-3 from sleep state 602-1. From ready state 602-3, the user may activate 610-4 the smart glass by pressing or touching a button in a contact sensor and set the device (e.g., a camera, or an immersive reality application) into active mode 602-4. Active state 602-4 may be induced into inactive state 602-2 by the user pressing 610-5 a button in a contact sensor to deactivate or turn a device or sensor off (e.g., a video camera, or an immersive reality application). In some embodiments, active state 602-4 may transition into inactive state 602-2 when the sensors in the smart glass do not sense skin contact (but detect hair contact) or sense a rotation motion from an IMU indicative that the smart glass is placed in the forehead or flipped in the back of the user’s head (cf. FIGS. 4A-4B). A signal 610-6 from contact sensors turning on the camera or an immersive reality application will turn the device from inactive state 602-2 to active state 602-4. In some embodiments. A signal 610-3 from an IMU sensor indicative that the smart glass is back in the user’s face will set the smart glass from inactive state 602-2 to ready state 602-3.

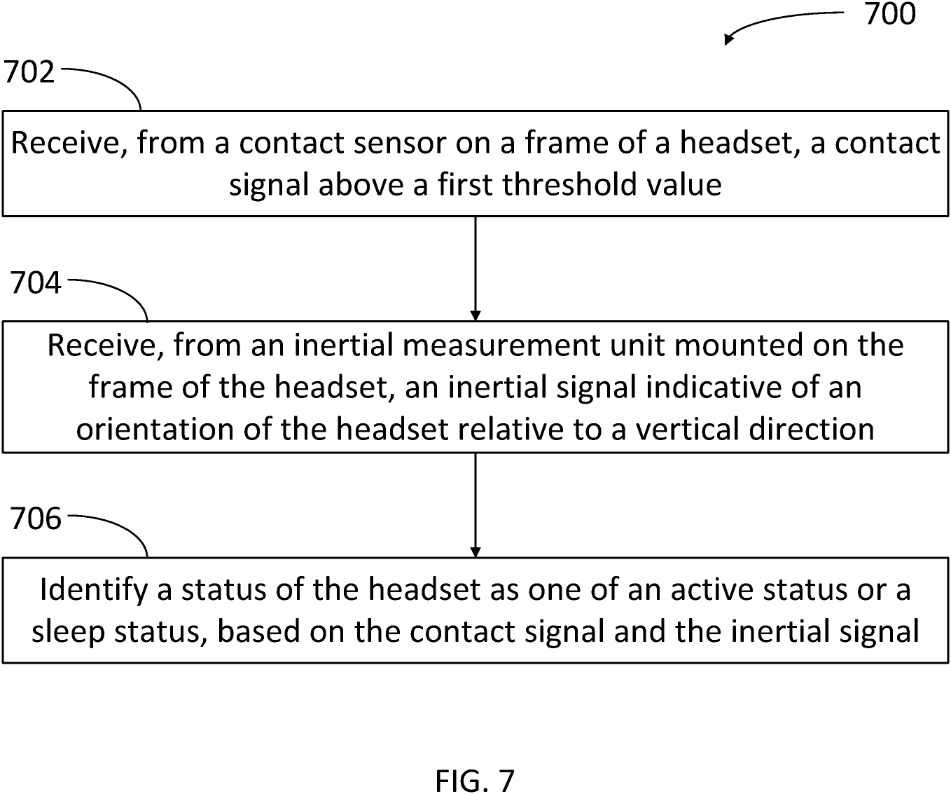

FIG. 7 is a flow chart illustrating steps in a method 700 for identifying a user command in a headset, according to some embodiments. In some embodiments, at least one or more of the steps in method 700 may be performed by a processor executing instructions stored in a memory in either one of a smart glass or other wearable device on a user’s body part (e.g., head, arm, wrist, leg, ankle, finger, toe, knee, shoulder, chest, back, and the like). In some embodiments, at least one or more of the steps in method 700 may be performed by a processor executing instructions stored in a memory, wherein either the processor or the memory, or both, are part of a mobile device for the user, a remote server or a database, communicatively coupled with each other via a network (cf. processors 112, 312, 412, and 512, memories 120, 320, 420, and 520, smart glasses 100, 200, 300, 400, and 500, wristband 102, mobile device 110, server 130, database 152, and network 150). Moreover, the mobile device, the smart glass, and the wearable devices may be communicatively coupled with each other via a wireless communication system and protocol (e.g., radio, Wi-Fi, Bluetooth, near-field communication -NFC- and the like as in communications module 118). In some embodiments, a method consistent with the present disclosure may include one or more steps from method 700 performed in any order, simultaneously, quasi-simultaneously, or overlapping in time.

Step 702 includes receiving, from a contact sensor mounted on a frame of a headset, a contact signal above a first threshold value.

Step 704 includes receiving, from an inertial measurement unit mounted on the frame of the headset, an inertial signal indicative of an orientation of the headset relative to a vertical direction. In some embodiments, the inertial measurement unit is configured to provide a signal for a sideways swing of a user’s head, and step 704 further includes identifying a negative response to an augmented reality content when receiving the signal. In some embodiments, the inertial measurement unit is configured to provide a signal for an up-down swing of a user’s head, and step 604 further includes identifying a positive response to an augmented reality content when receiving the signal.

Step 706 includes identifying a status of the headset as one of an active status or a sleep status, based on the contact signal and the inertial signal. In some embodiments, step 706 further includes switching the status of the headset between the active status and the sleep status, based on the contact signal and the inertial signal. In some embodiments, step 706 further includes receiving, from a hinge detector, a signal indicative of a position configuration of a hinge joining a temple with the frame of the headset. In some embodiments, step 706 includes receiving, from a camera mounted on the frame of the headset, an image of a forward field of view of the headset. In some embodiments, the contact signal is indicative of a contact of the frame with a user’s face, and the inertial signal is indicative of an orientation of the headset relative to a vertical position, and step 706 includes verifying the contact signal and verifying that the orientation of the headset is substantially parallel to the vertical position. In some embodiments, step 706 includes switching the headset from an active mode into a sleep mode or from a sleep mode into an active mode based on a signal from a hinge sensor, the signal indicative of one of a folding or an unfolding of a temple over the frame. In some embodiments, step 706 includes switching the headset from an active mode into a sleep mode or from a sleep mode into an active mode, based on an image provided by a forward-facing camera mounted on the frame. In some embodiments, step 706 further includes wirelessly transmitting, via a communications module, a signal to a remote device indicative of the active status or the sleep status of the headset.

### Hardware Overview

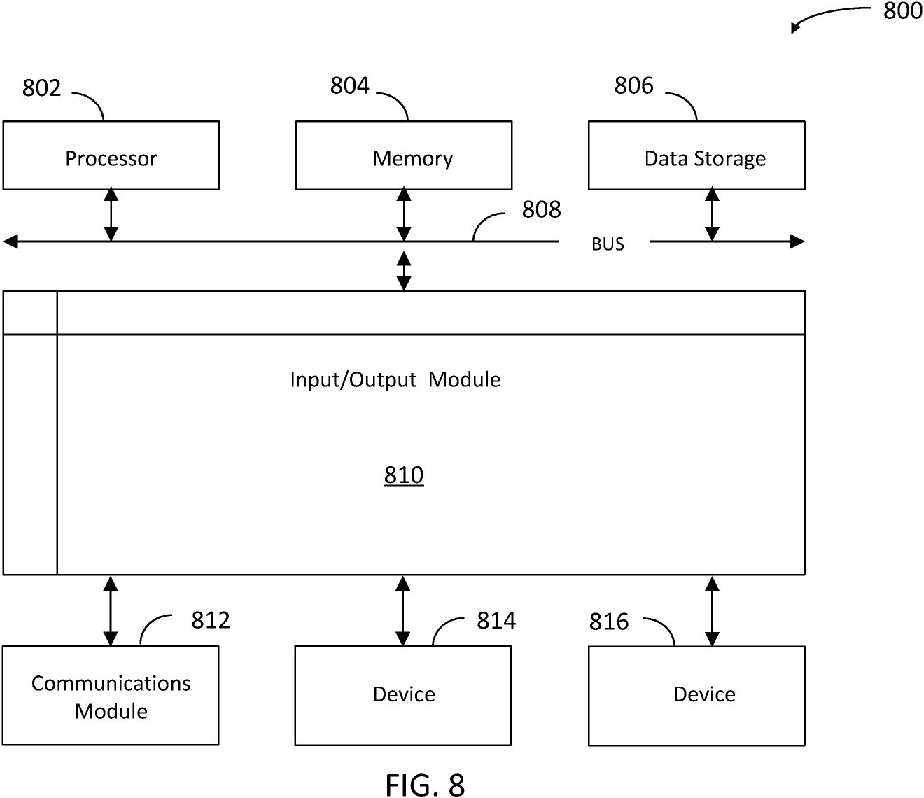

FIG. 8 is a block diagram illustrating an exemplary computer system 800 with which a VR, AR or MR headset, and methods of use can be implemented, according to some embodiments. In certain aspects, computer system 800 may be implemented using hardware or a combination of software and hardware, either in a dedicated server, or integrated into another entity, or distributed across multiple entities. Computer system 800 may include a desktop computer, a laptop computer, a tablet, a phablet, a smartphone, a feature phone, a server computer, or otherwise. A server computer may be located remotely in a data center or be stored locally.

Computer system 800 includes a bus 808 or other communication mechanism for communicating information, and a processor 802 coupled with bus 808 for processing information. By way of example, the computer system 800 may be implemented with one or more processors 802. Processor 802 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 800 can include, in addition to hardware, code that creates an execution environment for the computer program in question, e.g., code that constitutes processor firmware, a protocol stack, a database management system, an operating system, or a combination of one or more of them stored in an included memory 804, such as a Random Access Memory (RAM), a flash memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled with bus 808 for storing information and instructions to be executed by processor 802. The processor 802 and the memory 804 can be supplemented by, or incorporated in, special purpose logic circuitry.

The instructions may be stored in the memory 804 and implemented in one or more computer program products, e.g., one or more modules of computer program instructions encoded on a computer-readable medium for execution by, or to control the operation of, the computer system 800, and according to any method well known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, offside rule languages, procedural languages, reflective languages, rule-based languages, scripting languages, stack-based languages, synchronous languages, syntax handling languages, visual languages, Wirth languages, and xml-based languages. Memory 804 may also be used for storing temporary variable or other intermediate information during execution of instructions to be executed by processor 802.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 800 further includes a data storage device 806 such as a magnetic disk or optical disk, coupled with bus 808 for storing information and instructions. Computer system 800 may be coupled via input/output module 810 to various devices. Input/output module 810 can be any input/output module. Exemplary input/output modules 810 include data ports such as USB ports. The input/output module 810 is configured to connect to a communications module 812. Exemplary communications modules 812 include networking interface cards, such as Ethernet cards and modems. In certain aspects, input/output module 810 is configured to connect to a plurality of devices, such as an input device 814 and/or an output device 816. Exemplary input devices 814 include a keyboard and a pointing device, e.g., a mouse or a trackball, by which a consumer can provide input to the computer system 800. Other kinds of input devices 814 can be used to provide for interaction with a consumer as well, such as a tactile input device, visual input device, audio input device, or brain-computer interface device. For example, feedback provided to the consumer can be any form of sensory feedback, e.g., visual feedback, auditory feedback, or tactile feedback; and input from the consumer can be received in any form, including acoustic, speech, tactile, or brain wave input. Exemplary output devices 816 include display devices, such as an LCD (liquid crystal display) monitor, for displaying information to the consumer.

According to one aspect of the present disclosure, a VR headset as disclosed herein can be implemented, at least partially, using a computer system 800 in response to processor 802 executing one or more sequences of one or more instructions contained in memory 804. Such instructions may be read into memory 804 from another machine-readable medium, such as data storage device 806. Execution of the sequences of instructions contained in main memory 804 causes processor 802 to perform the process steps described herein. One or more processors in a multi-processing arrangement may also be employed to execute the sequences of instructions contained in memory 804. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., a data server, or that includes a middleware component, e.g., an application server, or that includes a front end component, e.g., a client computer having a graphical consumer interface or a Web browser through which a consumer can interact with an implementation of the subject matter described in this specification, or any combination of one or more such back end, middleware, or front end components. The components of the system can be interconnected by any form or medium of digital data communication, e.g., a communication network. The communication network can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computer system 800 can include clients and servers. A client and server are generally remote from each other and typically interact through a communication network. The relationship of client and server arises by virtue of computer programs running on the respective computers and having a client-server relationship to each other. Computer system 800 can be, for example, and without limitation, a desktop computer, laptop computer, or tablet computer. Computer system 800 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein refers to any medium or media that participates in providing instructions to processor 802 for execution. Such a medium may take many forms, including, but not limited to, non-volatile media, volatile media, and transmission media. Non-volatile media include, for example, optical or magnetic disks, such as data storage device 806. Volatile media include dynamic memory, such as memory 804. Transmission media include coaxial cables, copper wire, and fiber optics, including the wires forming bus 808. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter affecting a machine-readable propagated signal, or a combination of one or more of them.

The subject technology is illustrated, for example, according to various aspects described below. Various examples of aspects of the subject technology are described as numbered claims (claim 1, 2, etc.) for convenience. These are provided as examples and do not limit the subject technology.

In one aspect, a method may be an operation, an instruction, or a function and vice versa. In one aspect, a claim may be amended to include some or all of the words (e.g., instructions, operations, functions, or components) recited in either one or more claims, one or more words, one or more sentences, one or more phrases, one or more paragraphs, and/or one or more claims.

To illustrate the interchangeability of hardware and software, items such as the various illustrative blocks, modules, components, methods, operations, instructions, and algorithms have been described generally in terms of their functionality. Whether such functionality is implemented as hardware, software, or a combination of hardware and software depends upon the particular application and design constraints imposed on the overall system. Skilled artisans may implement the described functionality in varying ways for each particular application.

As used herein, the phrase “at least one of” preceding a series of items, with the terms “and” or “or” to separate any of the items, modifies the list as a whole, rather than each member of the list (e.g., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The word “exemplary” is used herein to mean “serving as an example, instance, or illustration.” Any embodiment described herein as “exemplary” is not necessarily to be construed as preferred or advantageous over other embodiments. Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A reference to an element in the singular is not intended to mean “one and only one” unless specifically stated, but rather “one or more.” Pronouns in the masculine (e.g., his) include the feminine and neuter gender (e.g., her and its) and vice versa. The term “some” refers to one or more. Underlined and/or italicized headings and subheadings are used for convenience only, do not limit the subject technology, and are not referred to in connection with the interpretation of the description of the subject technology. Relational terms such as first and second and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public, regardless of whether such disclosure is explicitly recited in the above description. No claim element is to be construed under the provisions of 35 U.S.C. §112, sixth paragraph, unless the element is expressly recited using the phrase “means for” or, in the case of a method claim, the element is recited using the phrase “step for.”

While this specification contains many specifics, these should not be construed as limitations on the scope of what may be described, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially described as such, one or more features from a described combination can in some cases be excised from the combination, and the described combination may be directed to a sub-combination or variation of a sub-combination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples, and the various features are grouped together in various implementations for the purpose of streamlining the disclosure. The method of disclosure is not to be interpreted as reflecting an intention that the described subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately described subject matter.

The claims are not intended to be limited to the aspects described herein but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A device, comprising:
a frame that supports two eyepieces;
a capacitive sensor mounted on the frame;
an inertial measurement unit mounted on the frame; and
a circuit component inside the frame, wherein the circuit component electrically couples the capacitive sensor and the inertial measurement unit with a processor and a memory inside the frame.

2. The device of claim 1, further comprising a hinge sensor electrically coupled with the processor and configured to determine a position configuration of a hinge joining a temple with the frame of the device.

3. The device of claim 1, further comprising a camera electrically coupled with the processor and the memory, and configured to provide an image of a forward field of view of the device.

4. The device of claim 1, wherein the capacitive sensor is configured to provide a contact signal indicative of a contact of the frame with a user’s face, and the inertial measurement unit is configured to provide an orientation signal indicative of an orientation of the two eyepieces relative to a vertical position, and wherein the processor is configured to identify an active use of the device based on the contact signal and the orientation signal.

5. The device of claim 1, further comprising a display in at least one of the two eyepieces, the display configured to provide an image to a user of the device when the processor determines that the user intends to activate the device based on a signal from the capacitive sensor and a signal from the inertial measurement unit.

6. The device of claim 1, wherein the inertial measurement unit is configured to provide a first signal for a sideways swing of a user’s head and a second signal for an up-down swing of the user’s head, and wherein the processor is configured to identify a negative response to an augmented reality content when receiving the first signal and a positive response to the augmented reality content when receiving the second signal.

7. The device of claim 1, wherein the processor is configured to switch the device from an active mode into a sleep mode or from a sleep mode into an active mode based on a first signal from the capacitive sensor and a second signal from the inertial measurement unit.

8. The device of claim 1, wherein the processor is configured to switch the device from an active mode into a sleep mode or from a sleep mode into an active mode based on a signal from a hinge sensor, the signal indicative of one of a folding or an unfolding of a temple over the frame.

9. The device of claim 1, wherein the processor is configured to switch the device from an active mode into a sleep mode or from a sleep mode into an active mode, based on an image provided by a forward facing camera mounted on the frame.

10. The device of claim 1, further comprising a communications module electrically coupled with the processor, wherein the processor is configured to wirelessly transmit, via the communications module, a signal to a remote device indicative of an active status or a sleep status of the device.

11. A computer-implemented method, comprising:
receiving, from a contact or proximity sensor mounted on a frame of a headset, a contact signal above a first threshold value;
receiving, from an inertial measurement unit mounted on the frame of the headset, an inertial signal indicative of an orientation of the headset relative to a vertical direction; and
identifying a status of the headset as one of an active status or a sleep status, based on the contact signal and the inertial signal.

12. The computer-implemented method of claim 11, further comprising switching the status of the headset between the active status and the sleep status, based on the contact signal and the inertial signal.

13. The computer-implemented method of claim 11, wherein identifying the status of the headset as one of an active status or a sleep status comprises receiving, from a hinge detector, a signal indicative of a position configuration of a hinge joining a temple with the frame of the headset.

14. The computer-implemented method of claim 11, wherein identifying the status of the headset as one of an active status or a sleep status comprises receiving, from a camera mounted on the frame of the headset, an image of a forward field of view of the headset.

15. The computer-implemented method of claim 11, wherein the contact signal is indicative of a contact of the frame with a user’s face, and the inertial signal is indicative of an orientation of the headset relative to a vertical position, and identifying an active status of the headset comprises verifying the contact signal and verifying that the orientation of the headset is substantially parallel to the vertical position.

16. The computer-implemented method of claim 11, wherein the inertial measurement unit is configured to provide a signal for a sideways swing of a user’s head, further comprising identifying a negative response to an augmented reality content when receiving the signal.

17. The computer-implemented method of claim 11, wherein the inertial measurement unit is configured to provide a signal for an up-down swing of a user’s head, further comprising identifying a positive response to an augmented reality content when receiving the signal.

18. The computer-implemented method of claim 11, further comprising:
switching the headset from an active mode into a sleep mode or from a sleep mode into an active mode based on one of a signal from a hinge sensor, the signal indicative of one of a folding or an unfolding of a temple over the frame, an image provided by a forward facing camera mounted on the frame.

19. A non-transitory, computer-readable medium including instructions which, when executed by a processor, cause a computer to perform operations, comprising:
receiving, from a contact or proximity sensor mounted on a frame of a headset, a contact signal above a first threshold value;
receiving, from an inertial measurement unit mounted on the frame of the headset, an inertial signal indicative of an orientation of the headset relative to a vertical direction;
identifying a status of the headset as one of an active status or a sleep status, based on the contact signal and the inertial signal;
switching the status of the headset between the active status and the sleep status, based on the contact signal and the inertial signal; and
wirelessly transmitting, via a communications module, a signal to a remote device indicative of the active status or the sleep status of the headset.

20. The non-transitory, computer-readable medium of claim 19, wherein the processor further executes instructions for identifying the status of the headset as one of an active status or a sleep status comprises receiving, from a hinge detector, a signal indicative of a position configuration of a hinge joining a temple with the frame of the headset.
